(19) United States
(12) Patent Application Publication
(10) Pub. No.: US 2006/0059521 A1
(43) Pub. Date: Mar. 16, 2006

(54) Method and system for integrating schedule management and broadcast program reservation in a terminal having functions of personal schedule management and broadcast program reservation

(75) Inventors: Kyung-Hee Lee, Seoul (KR); Sung-Chul Yang, Suwon-si (KR)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD., Suwon-si (KR)

(21) Appl. No.: 11/141,186

(22) Filed: May 31, 2005

(30) Foreign Application Priority Data
Sep. 16, 2004 (KR) 2004-74157

(51) Int. Cl. G06F 3/00; H04N 5/445; G06F 13/00

(52) U.S. Cl. 725/58; 725/39

(57) ABSTRACT

Disclosed are a method and a system for integrating schedule management and broadcast program reservation in a digital broadcasting hybrid terminal having functions of personal schedule management and broadcast program reservation. When a user inputs a schedule or a broadcast program reservation, all stored registrations are searched to inform the user of any conflicts with the inputted schedule or broadcast program reservation.

### PRIORITY

This application claims priority to an application entitled “Method and System for Interworking Schedule Management and Broadcast Program Reservation in Terminal Having Functions of Personal Schedule Management and Broadcast Program Reservation” filed with the Korean Intellectual Property Office on Sep. 16, 2004 and assigned Serial No. 2004-74157, the contents of which are hereby incorporated by reference.

### BACKGROUND OF THE INVENTION

1. Field of the Invention

The present invention relates to a terminal with hybrid functions, and more particularly to a terminal including a mobile terminal sub-system with a personal schedule management function and a digital broadcasting sub-system with a broadcast program reservation function.

2. Description of the Related Art

Mobile terminals such as mobile communication terminals, and PDAs (Personal Digital Assistants) generally have a personal schedule management function. Users can input their personal schedules for certain dates specified in a schedule management menu in mobile terminals to make sure everything gets done on time. For the scheduling services, PDAs receive scheduling data stored in a PC using a schedule management program and enable the users to input their monthly, weekly, daily, and hourly schedules. At every time and date specified, mobile terminals remind the users of the inputted schedules in visual and audible manners.

Recently, mobile terminals with a digital broadcasting receiver, such as DMB (Digital Multimedia Broadcasting) terminals, have been developed. Such terminals will be hereinafter referred to as “digital broadcasting hybrid terminals.” The digital broadcasting hybrid terminals have functions to manage schedules and provide digital broadcasting services that enable users to view and reserve digital broadcast programs. Broadcast program reservations include an alert for a program's start or to record a program. A user can register a program start alert for a specific broadcast program in a reservation menu while viewing EPG (Electronic Program Guide) information on a mobile terminal display. With the program start alert function, the mobile terminal will alert the user when the specific broadcast program starts. If the user registers a recording reservation for a program in the reservation menu while viewing EPG information, the mobile terminal will automatically record the corresponding program from its beginning.

Both the personal schedule management function and the broadcast program reservation function relate to the user's time management. In digital broadcast hybrid terminals, however, a mobile terminal sub-system for providing mobile phone services and a digital broadcasting sub-system for providing digital broadcasting services are separate and independent from each other. While schedule registration information for the personal schedule management is stored and managed in the memory of the mobile terminal sub-system, broadcast program reservation registration information for broadcast program reservations is stored and managed in the memory of the digital broadcasting sub-system. Accordingly, the personal schedule management function and the broadcast program reservation function are implemented separately by the mobile terminal sub-system and the digital broadcasting sub-system.

Although both the personal schedule management and the broadcast program reservation are functions relating to time management, digital broadcast hybrid terminals cannot integrate control and management of task and appointment scheduling with broadcast program reservations at the same time.

To schedule a task or appointment in consideration of any program reservations that have been previously registered, the user has to check the registered program start alerts in the broadcast program reservation menu. If a scheduled task or appointment overlaps a program start alert, the user will have to register the task or appointment schedule at a different time. Alternatively, the user will have to cancel the program start alerting reservation and register a recording reservation for the same program in the broadcast program reservation menu to register the schedule in the schedule management menu.

The reverse is true as well, to register a program start alert, the user has to check the registered schedules in the schedule management menu. If a program start alert overlaps a schedule, appointment or task, the user will have to first cancel the schedule in the schedule management menu and then register the program start alert reservation in the broadcast program reservation menu. Alternatively, the user may register a recording reservation for the same program without registering the program start alert reservation.

This process is problematic since it is inconvenient and troublesome to select the schedule management menu and the broadcast program reservation menu to check for conflicts between the schedule and program reservations.

The user may inadvertently register both a schedule and a program start alert that occur at the same time, without checking for conflicts because of the inconvenience involved. If the user does not register a recording reservation for the same program, the user will miss the program because he will not get the alert and the program will not be recorded.

### SUMMARY OF THE INVENTION

It is, therefore, an object of the present invention to provide a method and system for informing a user of conflicts between a personal schedule and a reserved program start alert time on a digital broadcasting hybrid terminal with personal schedule management and broadcast program reservations.

Another object of the present invention is to provide a method and system for preventing failure to view a selected program due to a conflict between a personal schedule and a reserved program start alert time on a digital broadcasting hybrid terminal with personal schedule management and broadcast program reservations.

Still another object of the present invention is to provide a method and system for integrated management of schedule registration information and broadcast program reservation information in a digital broadcasting hybrid terminal with personal schedule management and broadcast program reservation, thereby integrating the functions of schedule management and broadcast program reservation.

To accomplish the above objects of the present invention, there is provided a method and system for searching for information about previously registered schedules and broadcast program reservations before registering a new schedule or broadcast program reservation and informing a user when the new schedule or broadcast program reservation overlaps in time any of the registered schedules. and broadcast program reservations.

### BRIEF DESCRIPTION OF THE DRAWINGS

The above and other objects, features and advantages of the present invention will be more apparent from the following detailed description taken in conjunction with the accompanying drawings, in which:

FIG. 1 is a block diagram of a system for integrating schedule management and broadcast program reservation according to a first embodiment of the present invention;

FIG. 2 is a flow chart illustrating the operation of the controller of FIG. 1 to search for and store registration information;

FIG. 3 is a flow chart illustrating the operation of the controller of FIG. 1 to alert for a schedule or a reservation;

FIG. 4 is a flow chart illustrating the operation of the controller of FIG. 1 to register a schedule;

FIG. 5 is a flow chart illustrating the operation of the controller of FIG. 1 to register a broadcast program start alerting reservation;

FIG. 6 is a flow chart showing the operation of the controller of FIG. 1 to register a broadcast program recording reservation;

FIG. 7 is a block diagram of a system for integrating schedule management and broadcast program reservation according to a second embodiment of the present invention; and

FIG. 8 is a block diagram of a system for integrating schedule management and broadcast program reservation according to a third embodiment of the present invention.

### DETAILED DESCRIPTION OF THE PREFERRED EMBODIMENT

Hereinafter, preferred embodiments of the present invention will be described with reference to the accompanying drawings. In addition, in the following description of the present invention, a detailed description of known functions and configurations incorporated herein will be omitted when it may make the subject matter of the present invention unclear.

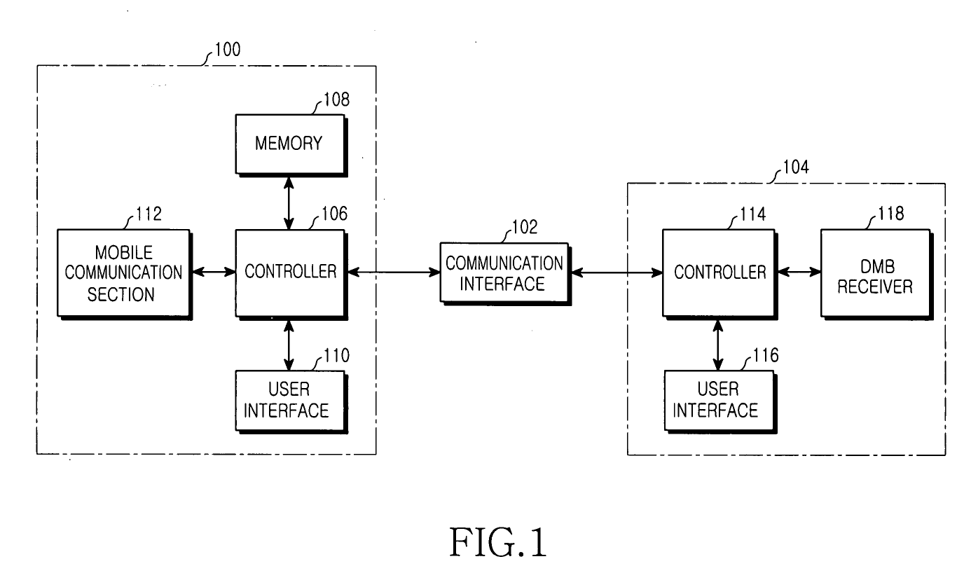

FIG. 1 is a block diagram of a system for integrating schedule management and broadcast program reservation according to a first embodiment of the present invention. As shown in FIG. 1, the present invention is applicable to a system incorporating a mobile terminal with a DMB terminal (hereinafter referred to as a “DMB hybrid terminal”). The system includes a mobile terminal sub-system 100 having a mobile communication function and a DMB sub-system 104 having a DMB receiving function as a digital broadcasting terminal.

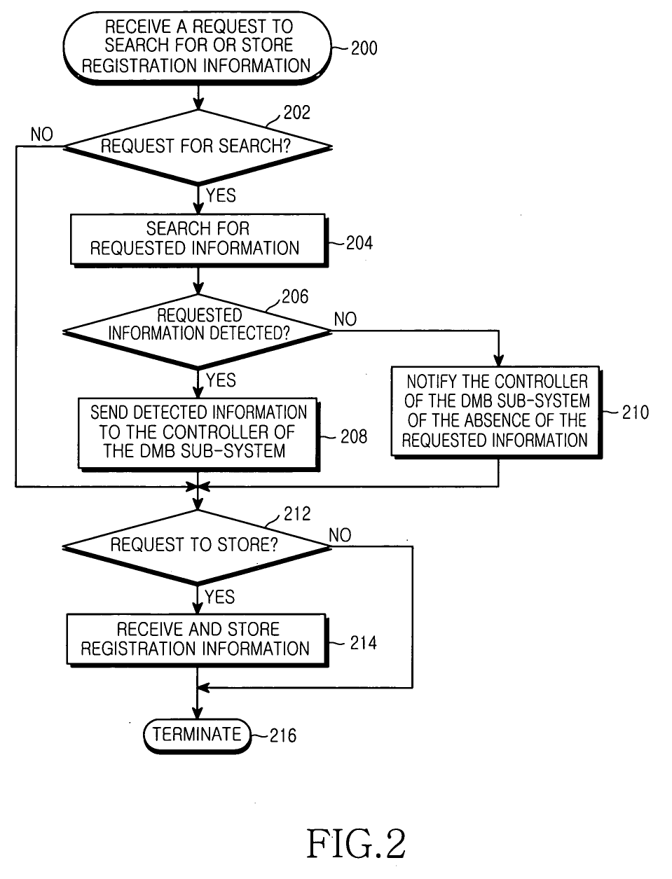

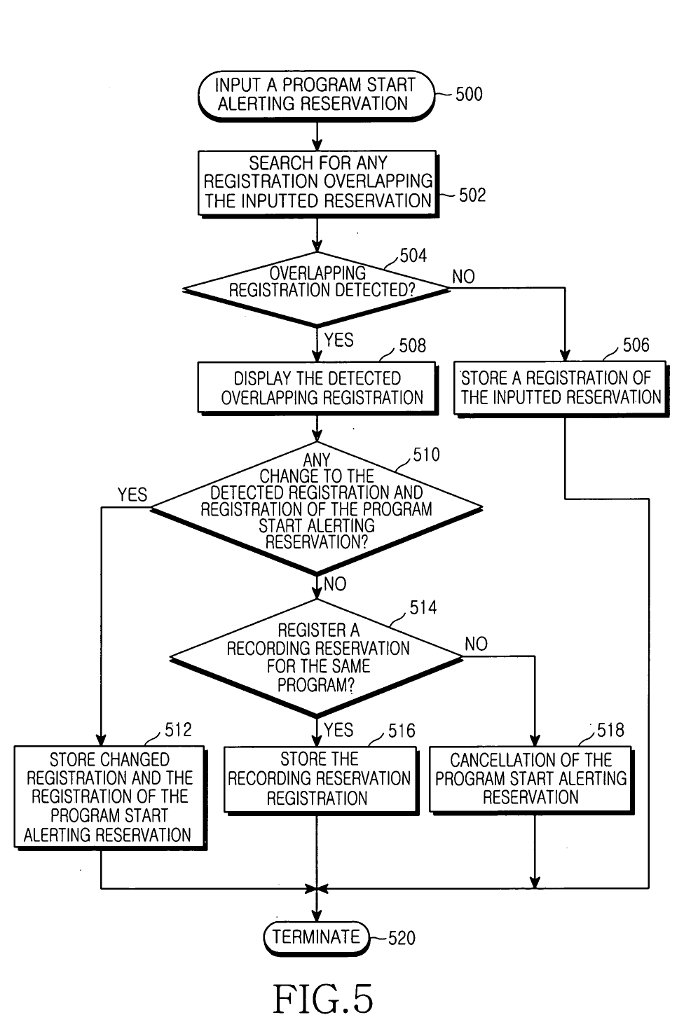

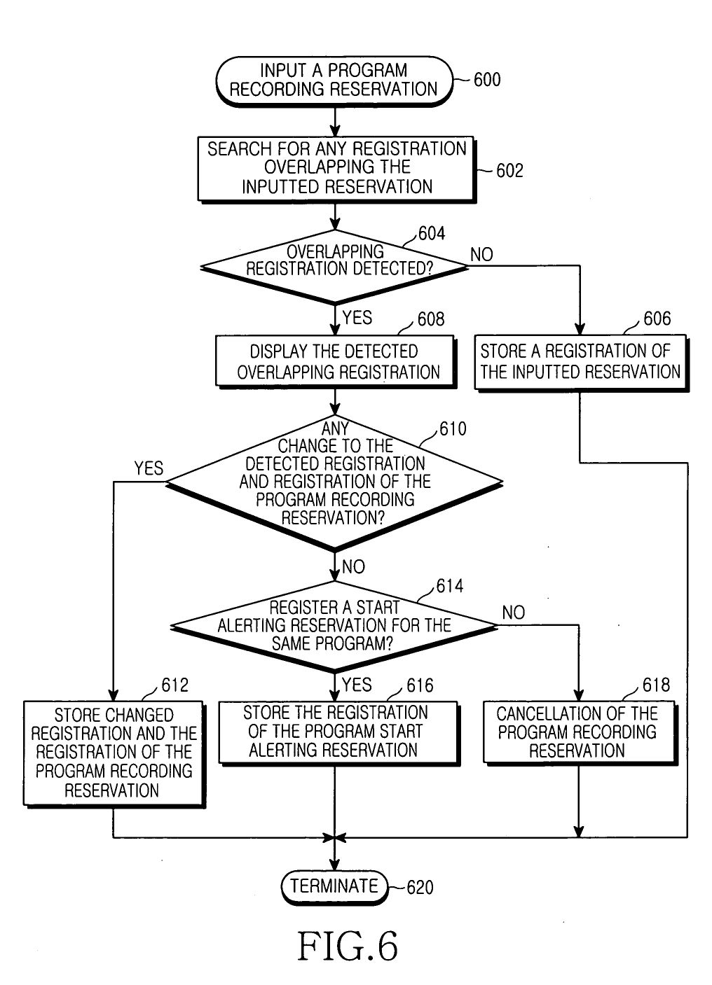

The mobile terminal sub-system 100 includes a controller 106, a memory 108, a user interface 110 and a mobile communication section 112. The DMB sub-system 104 includes a controller 114, a user interface 116 and a DMB receiver 118. The controller 106 can be the main controller of the mobile terminal sub-system 100 that operates as shown in the flow charts of FIGS. 2 to 4. The controller 114 can be the main controller of the DMB sub-system 104 that operates as shown in the flow charts of FIGS. 5 and 6.

The component for providing a general mobile communication function in the mobile terminal sub-system 100 is merely represented by the mobile communication section 112. Since this component is not significant to explain the present invention, its detailed explanation will be omitted. Similarly, the component for providing a general DMB receiving function in the DMB sub-system 104 is merely represented by the DMB receiver 118.

The mobile terminal sub-system 100 and the DMB sub-system 104 are connected to each other through a communication interface 102. The communication interface 102 enables communications between the mobile terminal sub-system 100 and the DMB sub-system 104. A DPRAM (Dual-Port Random Access Memory) that is generally used in communication between processors can be used as the communication interface 102. The controller 106 of the mobile terminal sub-system 100 communicates with the controller 114 of the DMB sub-system 104 due to the connection through the communication interface 102.

In the prior art, schedule registration information for the personal schedule management is stored and managed in the memory of the mobile terminal sub-system, and registration information for broadcast program reservations is stored and managed in the memory of the DMB sub-system. In the present invention, however, both the schedule registration information and the broadcast program reservation information are stored together in the memory 108 of the mobile terminal sub-system 100 for the integrated management of personal schedule and broadcast program information.

The controller 106 of the mobile terminal sub-system 100 is connected to the memory 108, the user interface 110 and the mobile communication section 112. In addition, the controller 106 is connected to the controller 114 of the DMB sub-system 104 through the communication interface 102. The controller 114 of the DMB sub-system 104 is connected to the user interface 116 and the DMB receiver 118. As explained above, the controllers 106 and 114 are connected to each other through the communication interface 102.

The controller 106 processes schedule registrations through the user interface 102, while the controller 114 processes broadcast program reservation registrations. Like a common user interface of a DMB hybrid terminal, the user interfaces 110 and 116 are used to transfer information between the user and the mobile terminal sub-system 100 and the DMB sub-system 104. Although not shown in the drawings, the user interfaces 110 and 116 may include a microphone, a speaker, a display device, a data port, a keypad and other components generally included in a common user interface. In FIG. 1, separate user interfaces 110 and 116 are provided for the mobile terminal sub-system 100 and the DMB sub-system 104, respectively. However, a single user interface can be commonly used for the mobile terminal sub-system 100 and the DMB sub-system 104 as can be in a conventional DMB hybrid terminal.

When the user inputs a broadcast program reservation with the user interface 116, the controller 114 searches registrations of time stored in the memory 108 to detect any registration that overlaps or conflicts with the inputted broadcast program reservation time and informs the user of the results of the search through the user interface 116. Specifically, the controller 114 requests the controller 106 to provide the results of a search for any registration of time overlapping the inputted broadcast program reservation time and receives the results through the communication interface 102. Also, the controller 114 stores the registration of the inputted broadcast program reservation in the memory 108. More specifically, the controller 114 requests the controller 106 to store the registration of the broadcast program reservation through the communication interface 102.

When the user inputs a schedule through the user interface 110, the controller 106 searches registrations of time stored in the memory 108 to detect any registration that conflict or overlap with the inputted schedule and provides the search results to the user via the user interface 110. The controller 106 stores the schedule registration in the memory 108. In addition, in response to the request from the controller 114, the controller 106 searches for and stores broadcast program reservation registrations received from the controller 114 through the communication interface 102.

The controller's 106 operation to search for and store registration information will be explained in detail with reference to FIG. 2. At step 200 in FIG. 2, the controller 106 receives a request to search for or store registration information from the controller 114. At step 202, the controller 106 determines whether the request received from the controller 114 asks to search for registration information. The controller 106 proceeds with step 204 if the request asks for a registration information search. If not, the process goes to step 212.

At step 204, the controller 106 searches for the requested registration information in the memory 108. If the requested registration information is detected, the controller 106 will transfer the detected information to the controller 114 through the communication interface 102 at step 208 and will then proceed with step 212. If not, the controller 106 will notify the controller 114 of the absence of the requested registration information through the communication interface 102 at step 210 and will then proceed with step 212.

At step 212, the controller 106 also determines whether the request received from the controller 114 asks to store any registration information. If the request asks to store registration information, the controller 106 will proceed with step 214 and store the registration information in the memory 108. At step 216, the controller 106 will terminate the process of searching for and/or storing registration information. If no request for storing registration information is received (step 212), the controller 106 will terminate the process of searching for the requested registration information at step 216.

According to the registration information stored in the memory 108, the controller 106 alerts the user at every reservation or scheduled time through the user interface 110 or informs the controller 114 through the communication interface 102.

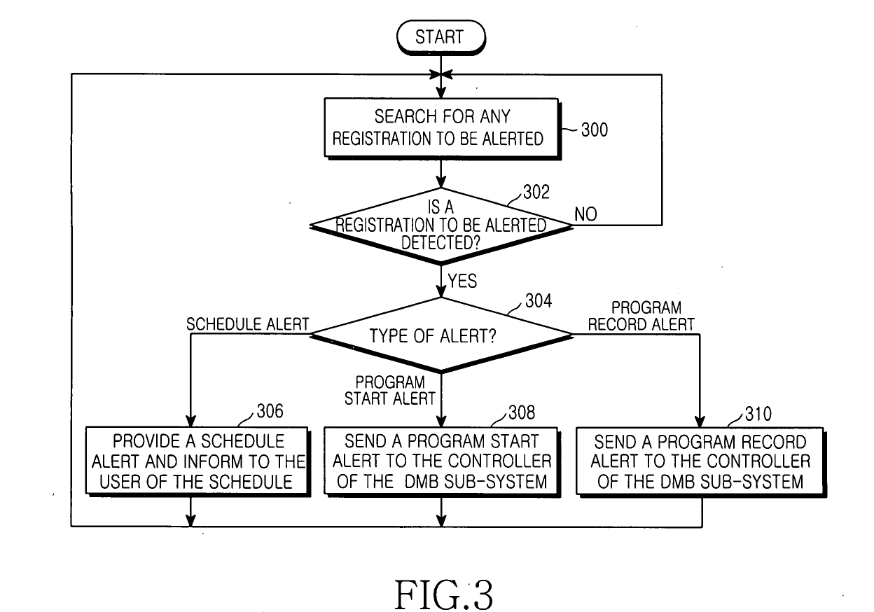

The controller's 106 operation to alert the user of a registered schedule or reservation time will be explained in detail with reference to FIG. 3. The controller 106 periodically performs steps 300 through 302 to search registrations stored in the memory 108 and determine whether it is time to alert the user of a registered schedule or reservation time. When any registration to be alerted is detected, the controller 106 determines the type of alert at step 304. The type of alert will be a schedule alert if the detected registration is a schedule registration, or a program start alert or a program record alert if the detected registration is a broadcast program reservation registration. The broadcast program reservation registration can be either a registration of a program start alert or a registration of a broadcast program recording reservation. The controller 106 will provide a program start alert or a program record alert according to the type of the broadcast program reservation registration.

If a schedule registration for an alert is detected at step 304, the controller 106 will provide a schedule alert corresponding to the detected registration through the user interface 110 at step 306. At this time, the controller 106 informs the user of the schedule in a visual and audible manner. If the detected registration relates to a broadcast program start alert, the controller 106 will send a program start alert corresponding to the detected registration to the controller 114 through the communication interface 102 at step 308. If the detected registration relates to a broadcast program recording reservation, the controller 106 will send a corresponding program record alert to the controller 114 through the communication interface 102 at step 310.

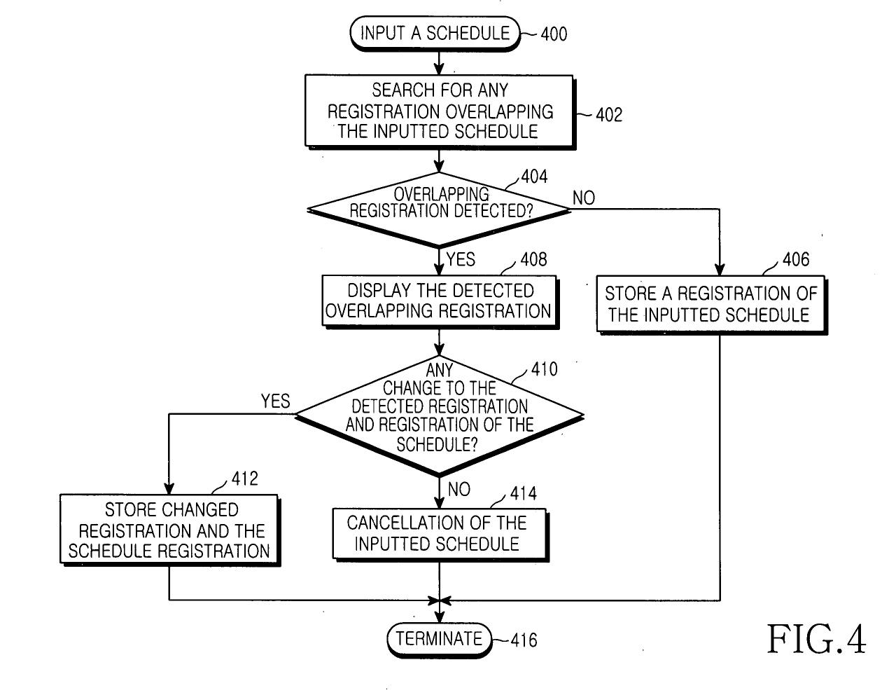

The controller's 106 operation to register a schedule will be explained in detail with reference to FIG. 4. When the user inputs a schedule in the schedule management menu through the user interface 110 at step 400, the controller 106 proceeds with step 402.

At step 402, the controller 106 searches registration information stored in the memory 108 to detect any registration that conflicts or overlaps with the intended schedule. According to the presence or absence of any registration conflict determined at step 404, the controller 106 proceeds with step 406 or 408. If a scheduling conflict is detected, the controller 106 will proceed with step 408 to inform the user through the user interface 110. The conflict can be a previous schedule registration or a registration of a broadcast program reservation (i.e., a broadcast program start alerting reservation or a broadcast program recording reservation). The conflict is displayed on the display window provided through the user interface 110.

As explained above, when the user inputs a new schedule, all previous registrations stored in the memory are searched to inform the user whether or not there are any conflicts.

In other words, the user can register an appointment or task with the schedule management menu, without having to check the broadcast program reservation schedules for conflicts. Thus, it is possible to prevent any conflicts or overlaps between a schedule and a broadcast program reservation time.

According to the overlapping registration information displayed at step 408, the user may cancel the inputted new schedule. Alternatively, the user may register the new schedule after changing the overlapping registration. If the user changes the overlapping registration through the user interface 110 and registers the new schedule at step 410, the controller 106 will store the change and the new schedule in the memory 108 at step 412 and will proceed with step 416 to terminate the schedule registering process. On the other hand, if the user selects cancellation of the new schedule at step 410, the controller 106 will cancel the input of the new schedule at step 414 and will proceed with step 416 to terminate the schedule registering process.

If no conflict is detected at step 404, the controller 106 will store the registration of the new schedule in the memory 108 at step 406 and will proceed with step 416 to terminate the schedule registering process.

The controller's 114 operation to register a broadcast program start alert will be explained in detail with reference to FIG. 5. When the user inputs a broadcast program start alert in the broadcast program reservation menu through the user interface 116 at step 500, the controller 114 proceeds with step 502.

At step 502, the controller 114 searches the registration information stored in the memory 108 to detect any conflicts with the new broadcast program start alert. To be specific, the controller 114 requests the controller 106 through the communication interface 102 to provide the results of a search for any registration of time overlapping with the inputted reservation time. In response to the request, the controller 106 searches for the overlapping registration as shown in FIG. 2 and sends the search results through the communication interface 102 to the controller 114. In other words, the controller 106 informs the controller 114 of the presence or absence of any conflicts through the communication interface 102.

At step 504, the controller 114 analyzes the search results received from the controller 106 through the communication interface 102. If the results show that a conflict exists, the controller 114 will proceed with step 508. At step 508, the controller 114 informs the user of the conflict through the user interface 116. The conflict may involve a scheduled appointment, task, or another broadcast program. The detected conflict is displayed on the display window through the user interface 116.

As explained above, when the user inputs a new broadcast program start alert, all previous registrations stored in the memory are searched to inform the user if there is any conflict.

In other words, the user can register the new broadcast program start alert without the need to use the schedule management menu to check for conflicts. Thus, it is possible to prevent conflicts between a scheduled event and a broadcast program reservation.

According to the conflict information displayed at step 508, the user may cancel the new program start alert. Alternatively, the user may register the program start alert after changing the overlapping registration. If the conflict relates to an important schedule or a broadcast program that the user wishes to view, the user can register a recording reservation for the same program, while canceling the program start alert.

If the user changes the conflicting registration through the user interface 116 and registers the new program start alert at step 510, the controller 114 will store the changed registration and the registration of the new program start alert in the memory 108 at step 512 and will proceed with step 520 to terminate the registration process. At this time, the controller 114 sends a request to store the changed registration and the registration of the new program start alert to the controller 106 through the communication interface 102. In response to the request, the controller 106 stores the registration information received from the controller 114 through the communication interface 102 in the memory 108 as shown in FIG. 2.

On the other hand, if the user cancels the new program start alert, the controller 114 will determine whether the user registers a recording reservation for the same program at step 514. According to the determination, the controller 114 will proceed with step 516 or 518. If the user registers a recording reservation for the same program, the controller 114 will store the program recording reservation in the memory 108 at step 516 and will proceed with step 520 to terminate the registration process. At this time, the controller 114 sends a request to store the registration of the program recording reservation to the controller 106 through the communication interface 102. In response to the request, the controller 106 stores the registration information received from the controller 114 through the communication interface 102 in the memory 108 as shown in FIG. 2.

If the user cancels the new program start alert, without registering a recording reservation for the same program, the controller 114 will cancel the new program start alert at step 518 and proceed with step 520 to terminate the registration process.

If no conflict is detected at step 504, the controller 114 will proceed with step 506 to store the registration of the new reservation input at step 500 in the memory 108 and proceed with step 520 to terminate the registration process. At this time, the controller 114 sends a request to store the registration of the new reservation to the controller 106 through the communication interface 102. In response to the request, the controller 106 stores the registration information received from the controller 114 through the communication interface 102 in the memory 108 as shown in FIG. 2.

As explained above, when it is time to alert the user of a program's start according to the registration of a broadcast program start alerting reservation, the controller 106 sends a program start alert to the controller 114 through the communication interface 102 as shown in FIG. 3. Then the controller 114 informs the user of the program's start in a visual and audible manner through the user interface 116. At the same time, the controller 114 receives the corresponding program through the DMB receiver 118 and outputs the video and audio broadcasting data through the user interface 116.

Hereinafter, the controller's 114 operation to register a broadcast program recording reservation will be explained in detail with reference to FIG. 6. When the user inputs a broadcast program recording reservation in the broadcast program reservation menu through the user interface 116 at step 600, the controller 114 proceeds with step 602.

At step 602, the controller 114 searches registration information stored in the memory 108 to detect any conflicts with the input recording reservation. At this time, the controller 114 requests the controller 106 to provide search results for any conflicts with the input reservation time and receives the results through the communication interface 102.

At step 604, the controller 114 analyzes the search results received from the controller 106. If the results show that a conflict exists, the controller 114 will proceed with step 608. At step 608, the controller 114 informs the user of the conflict detected by the controller 106 through the user interface 116.

As explained above, when the user inputs a new broadcast program recording reservation, all previous registrations stored in the memory are searched for a conflict.

According to the conflict information displayed at step 608, the user may cancel the program recording reservation. Alternatively, the user may register the program recording reservation or a start alert for the same program after changing the conflict.

If the user changes the conflicting registration through the user interface 116 and registers the new program recording reservation at step 610, the controller 114 will send a request to store the changed registration and the registration of the new program recording reservation to the controller 106 through the communication interface 102 at step 612. In response to the request, the controller 106 stores the registration information received from the controller 114 through the communication interface 102 in the memory 108. Then the controller 114 terminates the registration process at step 620.

On the other hand, if the user cancels the new program recording reservation, without changing the conflicting registration, the controller 114 will determine whether the user registers a start alert for the same program at step 614. According to the determination, the controller 114 will proceed with step 616 or 618. If the user registers a program start alert, the controller 114 will request the controller 106 through the communication interface 102 to store the registration of the program start alert in the memory 108 at step 616 and will proceed with step 620 to terminate the registration process.

If the user cancels the new program recording reservation, without registering a start alert for the same program, the controller 114 will cancel the input of the program recording reservation at step 618 and will proceed with step 620 to terminate the registration process.

If no conflict with the new program recording reservation is detected at step 604, the controller 114 will request the controller 106 through the communication interface 102 to store the registration of the program recording reservation inputted at step 600 in the memory 108 at step 606 and will proceed with step 620 to terminate the registration process. At this time, the controller 114 sends a request to store the registration of the new reservation to the controller 106 through the communication interface 102.

When it is time to alert the user of a registered program recording reservation, the controller 106 sends a program record alert to the controller 114 through the communication interface 102 as shown in FIG. 3. Then the controller 114 informs the user of the commencement of program recording in a visual and audible manner through the user interface 116. Simultaneously, the controller 114 receives the corresponding program through the DMB receiver 118 and records the received video and audio broadcast data.

As explained above, the DMB hybrid terminal according to the present invention stores and manages both schedule registrations and broadcast program reservation registrations in a single memory 108 to integrate schedule management and broadcast program reservations to inform the user of any conflict between a personal schedule and a program reservation time. Accordingly, it is possible to prevent the user from missing a selected program because of a scheduling conflict between a personal schedule and the program start time.

In accordance with the first embodiment as explained above, scheduled events, such as appointments and tasks, and broadcast program reservation registrations are all stored in the memory of the mobile terminal sub-system for integrated management. However, it is also possible to store and manage the schedule registrations and the broadcast program reservation registration in the memory of the DMB sub-system in order to integrate schedule and broadcast program reservation management.

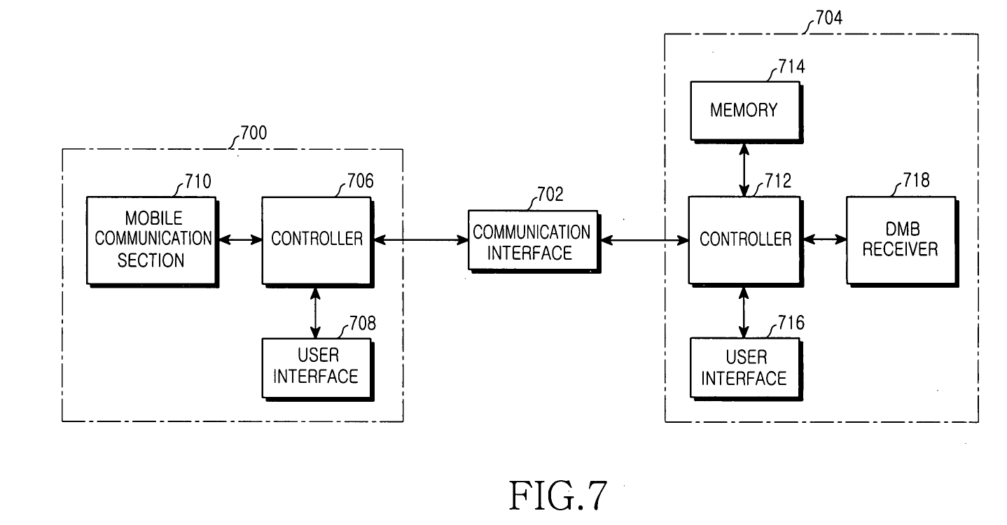

FIG. 7 is a block diagram of a system for integrating schedule and broadcast program reservation management according to a second embodiment of the present invention. Unlike the first embodiment shown in FIG. 1, the system in FIG. 7 uses the memory of the DMB sub-system, instead of the memory of the mobile terminal sub-system, to store schedule registrations and broadcast program reservation registrations.

Referring to FIG. 7, the mobile terminal sub-system 700 includes a controller 706, a user interface 708 and a mobile communication section 710. The DMB sub-system 704 includes a controller 712, a memory 714, a user interface 716 and a DMB receiver 718. The mobile terminal sub-system 700 and the DMB sub-system 704 are connected to each other through a communication interface 702 for communications therebetween. The controller 706 of the mobile terminal sub-system 700 communicates with the controller 712 of the DMB sub-system 704 via a connection to the communication interface 702.

The controller 706 of the mobile terminal sub-system 700 is connected to the user interface 708 and the mobile communication section 710. Also, the controller 706 is connected to the controller 712 of the DMB sub-system 704 through the communication interface 702. The controller 712 of the DMB sub-system 704 is connected to the memory 714, the user interface 716 and the DMB receiver 718. As explained above, the controllers 706 and 712 are connected to each other through the communication interface 702. Like the memory 108 in FIG. 1, the memory 714 stores schedule registrations and broadcast program reservation registrations together.

The controller 706 processes schedule registrations through the user interface 708, while the controller 712 processes broadcast program reservation registrations through the user interface 716. The user interfaces 708 and 716 correspond respectively to the user interfaces 110 and 116 in FIG. 1.

When the user inputs a broadcast program reservation with the user interface 716, the controller 712 searches registrations stored in the memory 714 to detect conflicts with the inputted broadcast program reservation time. The controller 712 informs the user of the presence or absence of a conflict with the user interface 716 and stores a registration of the broadcast program reservation in memory 714. Also, in response to the request from the controller 706, the controller 712 searches for stored registration information and stores schedule registrations received from the controller 706 through the communication interface 702.

When the user inputs a schedule through the user interface 708, the controller 706 searches registrations of time stored in the memory 714 to detect any conflicts with the inputted schedule and informs the user of the result via the user interface 708. Specifically, the controller 706 requests the controller 712 to provide the search results for any conflicts, which are supplied through the communication interface 702. In addition, the controller 706 stores registration of the inputted schedule in memory 714. More specifically, the controller 706 requests the controller 712, through the communication interface 702, to store a registration of the schedule.

The second embodiment shown in FIG. 7 is basically identical to the first embodiment shown in FIGS. 1 to 6, one difference being that the memory 714 provided in the DMB sub-system 704 stores and manages schedule registrations and broadcast program reservation registrations. In other words, the controller 712 performs the operations in the flow chart of FIG. 2 to search for registration information and store a schedule registration received upon request from the controller 706. Accordingly, steps 208 and 210 in FIG. 2 are performed by the controller 706 of the mobile terminal sub-system 700, instead of the controller 712 of the DMB sub-system 704.

In addition, the controller 712, rather than the controller 706, searches the registrations stored in the memory 714 to detect any conflicts according to the process flow in FIG 3. When any conflict is detected, the controller 712 determines the type of alert. If the detected conflict involves a schedule registration, the controller 712 sends a schedule alert to the controller 706 through the communication interface 702. If the detected conflict involves a broadcast program reservation, the controller 712 will provide the user with a program start alert or a program record alert and will perform the necessary procedure. Specifically, if a conflict is detected at step 304 in FIG. 3, the controller 712 will send a schedule alert to the controller 706 through the communication interface 702, without directly informing the user of the schedule (step 306). If the registration detected at step 304 relates to a broadcast program start alerting reservation or a broadcast program recording reservation, the controller 712 will provide the user with a program start alert or a program recording alert and will perform the necessary processes at steps 308 and 310.

In accordance with the first and second embodiments of the present invention, one of the sub-systems has a memory for storing both schedule registrations and broadcast program reservation registrations for integrated management. In accordance with the third embodiment of the present invention, separate memories are provided for the two sub-systems. While the two memories store schedule registrations and broadcast program reservation registrations, respectively, they can manage all the stored registrations, thereby integrating the schedule management function and the broadcast program reservation function.

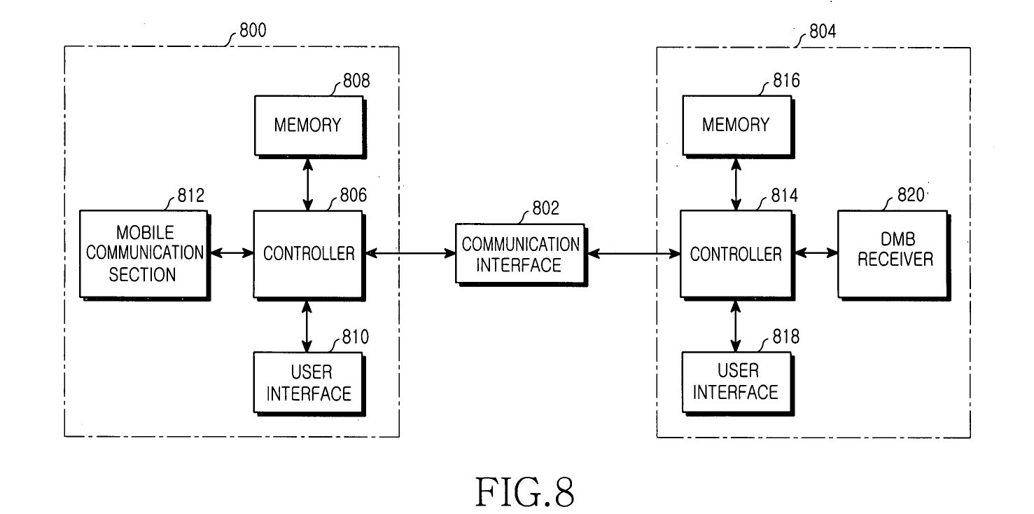

FIG. 8 is a block diagram of a system for integrating schedule and broadcast program reservation management according to the third embodiment of the present invention. The system stores schedule registrations and broadcast program reservation registrations in a memory 808 of a mobile terminal sub-system 800 and a memory 816 of a DBM sub-system 804, respectively. Like the mobile terminal sub-system 100 in FIG. 1, the mobile terminal sub-system 800 in FIG. 8 includes a controller 806, a memory 808, a user interface 810 and a mobile communication section 812. Like the DMB sub-system in FIG. 7, the DMB sub-system 804 includes a controller 814, a memory 816, a user interface 818 and a DMB receiver 820. The mobile terminal sub-system 800 and the DMB sub-system 804 are connected to each other through the communication interface 802 for communications therebetween. The controller 806 of the mobile terminal sub-system 800 communicates with the controller 814 of the DMB sub-system 804 via the connection to the communication interface 802. The memory 808 stores only schedule registrations. Unlike the memory 108 in FIG. 1, the memory 808 does not store broadcast program reservation registrations.

The controller 806 of the mobile terminal sub-system 800 is connected to the memory 808, the user interface 810 and the mobile communication section 812. In addition, the controller 806 is connected to the controller 814 of the DMB sub-system 804 via the communication interface 802. The controller 814 of the DMB sub-system 804 is connected to the memory 816, the user interface 818 and the DMB receiver 820. As explained above, the controllers 806 and 814 are connected to each other through the communication interface 802. The memory 816 stores broadcast program reservation registrations. Unlike the memory 714 in FIG. 7, the memory 816 does not store schedule registrations.

The controller 806 processes schedule registrations through the user interface 810, while the controller 814 processes broadcast program reservation registrations through the user interface 818. Like the user interfaces 708 and 716 in FIG. 7, the user interfaces 810 and 818 correspond respectively to the user interfaces 110 and 116 in FIG. 1.

When the user inputs a schedule through the user interface 810, the controller 806 searches registrations of time stored in the two memories 808 and 816 to detect any conflicts with the inputted schedule and informs the user whether any exist through the user interface 810. The controller 806 requests the controller 814 through the communication interface 802, to search the memory 816 for any conflicts and receives the search results through the communication interface 802. The controller 806 stores a registration of the inputted schedule in the memory 808. In addition, the controller 806 searches for registration information requested by the controller 814 through the communication interface 802.

When the user inputs a broadcast program reservation with the user interface 818, the controller 814 searches in the two memories 808 and 816 for any conflicts with the inputted broadcast program reservation and informs the user whether any were found via the user interface 818. The controller 814 requests the controller 806 via the communication interface 802 to search the memory 808 for any conflicts with the inputted reservation time and receives the search results through the communication interface 802. The controller 814 stores a registration of the broadcast program reservation in the memory 816. Also, the controller 814 searches for registration information requested by the controller 806.

The controller 806 or 814 performs the operations in the flow chart of FIG. 2 to search for registration information requested from the counterpart controller 814 or 806. Accordingly, steps 212 to 214 in FIG. 2 are skipped. At steps 208 and 210, the controller 806 transfers a detected registration information to the controller 814 through the communication interface 802 or informs the controller 814 of the absence of the requested registration information through the communication interface 802. Alternatively, at steps 208 and 210, the controller 814 may transfer a detected registration information to the controller 806 through the communication interface 802 or informs the controller 806 of the absence of the requested registration information through the communication interface 802.

Also, the controllers 806 and 814 alert the user of a registered schedule or reservation time by-a method as explained above. The controller 806 searches the memory 808 to detect any registration to be alerted. When any schedule registration to be alerted is detected, the controller 806 provides a schedule alert and informs the user of the corresponding schedule. The controller 814 searches the memory 816 to detect any registration to be alerted. When any program reservation registration to be alerted is detected, the controller 814 provides a program start alert or a program record alert according to the type of the program reservation detected As explained above, the present invention enables integrated management of personal schedules and broadcast program reservations in a terminal with personal schedule and broadcast program reservation management. With the two functions working together, the user can easily register a new schedule or program reservation and check for conflicts at the same time.

When the new schedule or program reservation conflicts with any of the previously stored registrations, the user is informed so he does not miss the selected broadcast. The user can then register a recording reservation for the program, instead of a program start alert that would conflict with his schedule.

Although preferred embodiments of the present invention have been described for illustrative purposes, those skilled in the art will appreciate that various modifications, additions and substitutions are possible, without departing from the scope and spirit of the invention as disclosed in the accompanying claims, including the full scope of equivalents thereof.

What is claimed is:

1. A method for integrating schedule management and broadcast program reservation in a mobile terminal with a schedule management sub-system and a digital broadcasting sub-system, the method comprising:
searching for any registration of time that overlaps with an inputted schedule or broadcast program reservation when a user inputs the schedule or broadcast program reservation; and
informing the user of the detected conflict when a conflicting registration is detected.

2. The method of claim 1, further comprising the steps of:
storing a registration of the schedule in a memory provided in one of the mobile terminal sub-system and the digital broadcasting sub-system when no registration of time overlaps the inputted schedule; and
storing a registration of the broadcast program reservation in the memory when no registration of time overlaps the inputted broadcast program reservation.

3. The method of claim 1, wherein said broadcast program reservation includes a broadcast program start alert and a broadcast program recording reservation.

4. The method of claim 2, wherein said broadcast program reservation includes a broadcast program start alert and a broadcast program recording reservation.

5. The method of claim 1, further comprising the steps of:
storing a registration of the schedule in a memory provided in the mobile terminal sub-system when no registration of time overlaps the inputted schedule; and, storing a registration of the broadcast program reservation in a memory provided in the digital broadcasting sub-system when no registration of time overlaps the inputted broadcast program reservation.

6. The method of claim 1, wherein said broadcast program reservation includes a broadcast program start alert and a broadcast program recording reservation.

7. The method of claim 5, wherein said broadcast program reservation includes a broadcast program start alert and a broadcast program recording reservation.

8. A system for integrating schedule management and broadcast program reservation in a mobile terminal comprising:
a schedule management sub-system;
a digital broadcast sub-system;
a memory for storing schedule registrations and broadcast program reservation registrations;
a first controller for searching the memory to detect any registration of time that conflicts with a schedule input by a user, informing the user of the presence or absence of a detected conflict and storing a registration of the inputted schedule in the memory; and
a second controller for searching the memory to detect any registration of time that conflicts with a broadcast program reservation input by the user, informing the user of the presence or absence of a detected conflict and storing a registration of the inputted broadcast program reservation in the memory.

9. The system of claim 8, wherein said broadcast program reservation includes a broadcast program start alert and a broadcast program recording reservation.

10. The system of claim 8, further comprising a communication interface for enabling communications between the schedule management sub-system and the digital broadcasting sub-system, wherein said memory is provided in the schedule management sub-system and connected to the first controller, and wherein said first and second controllers are provided respectively in the schedule management sub-system and the digital broadcasting sub-system and connected to each other through the communication interface.

11. The system of claim 10, wherein said first controller searches registrations stored in the memory to detect any conflicts and sends an alert for the corresponding program reservation to the second controller.

12. The system of claim 10, wherein said broadcast program reservation includes a broadcast program start alert and a broadcast program recording reservation.

13. The system of claim 11, wherein said broadcast program reservation includes a broadcast program start alert and a broadcast program recording reservation.

14. The system of claim 8, further comprising a communication interface for enabling communications between the schedule management sub-system and the digital broadcasting sub-system, wherein said memory is provided in the digital broadcasting sub-system and connected to the second controller, and wherein said first and second controllers are provided respectively in the schedule management sub-system and the digital broadcasting sub-system and connected to each other through the communication interface.

15. The system of claim 14, wherein said second controller searches registrations stored in the memory to detect any schedule registration to be alerted and sends an alert for the corresponding schedule reservation to the first controller.

16. The system of claim 14, wherein said broadcast program reservation includes a broadcast program start alert and a broadcast program recording reservation.

17. The system of claim 15, wherein said broadcast program reservation includes a broadcast program start alert and a broadcast program recording reservation.

18. A system for integrating schedule management and broadcast program reservation in a mobile terminal with a schedule management sub-system and a digital broadcasting sub-system comprising:
a first memory for storing schedule registrations;
a second memory for storing broadcast program reservation registrations;
a first controller for searching the first and second memories to detect any registration of time that conflicts with a schedule inputted by a user, informing the user of the presence or absence of a detected schedule conflict and storing a registration of the inputted schedule in the first memory; and
a second controller for searching the first and second memories to detect any registration of time that conflicts with a broadcast program reservation inputted by the user, informing the user of the presence or absence of a detected program conflict and storing a registration of the inputted broadcast program reservation in the second memory.

19. The system of claim 18, further comprising a communication interface for enabling communications between the schedule management sub-system and the digital broadcasting sub-system, wherein said first memory is provided in the schedule management sub-system and connected to the first controller, while said second memory is provided in the digital broadcasting sub-system and connected to the second controller, and wherein said first and second controllers are provided respectively in the schedule management sub-system and the digital broadcasting sub-system and connected to each other through the communication interface.

20. The system of claim 18, wherein said broadcast program reservation includes a broadcast program start alert and a broadcast program recording reservation.

21. The system of claim 19, wherein said broadcast program reservation includes a broadcast program start alert and a broadcast program recording reservation.
